(19) United States
(12) Patent Application Publication
(10) Pub. No.: US 2015/0105302 A1
(43) Pub. Date: Apr. 16, 2015

(54) SYSTEMS, METHODS, AND COMPOSITIONS COMPRISING AN EMULSION OR A MICROEMULSION AND CHLORINE DIOXIDE FOR USE IN OIL AND/OR GAS WELLS

(71) Applicant: CESI Chemical, Inc., Houston, TX (US)

(72) Inventors: John T. Pursley, Highlands Ranch, CO (US); Glenn S. Penny, Lakewood, CO (US); Charles Earl Hammond, Sugar Land, TX (US)

(73) Assignee: CESI Chemical, Inc., Houston, TX (US)

(21) Appl. No.: 14/509,309

(22) Filed: Oct. 8, 2014

Related U.S. Application Data
(60) Provisional application No. 61/946,071, filed on Feb. 28, 2014.
(60) Provisional application No. 61/891,316, filed on Oct. 15, 2013.
(60) Provisional application No. 61/888,098, filed on Oct. 8, 2013.

(51) Int. Cl. C09K 8/58

(52) U.S. Cl. CPC C09K 8/58
USPC 507/202; 507/203

(57) ABSTRACT

The present invention generally provides systems, methods, and compositions comprising an emulsion or a microemulsion and chlorine dioxide for use in oil and/or gas wells. In some embodiments, the systems, methods, and/or compositions comprise reducing the viscosity a fluid comprising a polymer, wherein the fluid was utilized in the recovery of oil and/or gas from the oil and/or gas well.

### RELATED APPLICATIONS

The present application claims priority under 35 U.S.C. §119(e) to U.S. provisional application, U.S. Ser. No. 61/888,098, filed Oct. 8, 2013, entitled “System and Method for Well Applications”; U.S. provisional application, U.S. Ser. No. 61/891,316, filed Oct. 15, 2013, entitled “System and Method for Well Applications”; and U.S. Ser. No. 61/946,071, filed Feb. 28, 2014, entitled “Systems, Methods, and Compositions Comprising an Emulsion or a Microemulsion and Chlorine Dioxide for Use in Oil and/or Gas Wells”, each of which is incorporated herein by reference.

### FIELD OF INVENTION

The present invention generally provides systems, methods, and compositions comprising an emulsion or a microemulsion and chlorine dioxide for use in oil and/or gas wells.

### BACKGROUND OF INVENTION

Well stimulation treatments are commonly used to initiate, enhance, or restore the productivity of a well or hydrocarbon producing field. Hydraulic fracturing is a particularly common well stimulation technique that involves the high-pressure injection of specially engineered treatment fluids into the reservoir. The high-pressure treatment fluid, which often includes polymers or gellants to viscosify, thicken, or gel the treatment fluid, causes a fracture to extend away from the wellbore into the formation (reservoir) according to the natural stresses of the formation. The polymers or gellants include natural products such as polysaccharide polymers like guar gum, guar derivatives, biopolymers, cellulose, and its derivatives or synthetic polymers like polyacrylamides. Viscoelastic surfactants are also widely used instead of polymers in fracturing fluids. Propping agents, usually called proppants, such as grains of sand of a particular size, are often mixed with the treatment fluid to keep the fracture open after the high-pressure subsides when treatment is complete. The increased permeability resulting from the stimulation operation enhances the flow of hydrocarbons into the wellbore. Proppants can include sand, glass beads, ceramic proppants, resin coated sands, resin coated ceramic proppants, on the fly coated proppants, and the like.

In addition to hydraulic fracturing, enhanced oil recovery (EOR) can be used to further recover hydrocarbons from a wellbore. EOR methods include but are not limited to gas flooding (CO₂, N₂, and hydrocarbons and/or solvents), thermal flooding (steam injection, SAGD (steam assisted gravity drainage), etc.), and chemical flooding (Polymer Flooding, surfactant flooding, alkali surfactant polymer flooding). Polymer flooding is growing as a result of the limitations associated with the alternative EOR methods. However, hidden operating costs can arise shortly after the first oil bank breakthrough.

Once the polymer flood water is used, it contains high concentrations of polymer, high concentrations of oil in the form of an emulsion, and potentially many other types of organic and inorganic compounds. The industry is desirous of reusing such water for subsequent processes. Furthermore, oil is generally produced in a suspension, emulsion or complex consisting of oil, unbroken gels, bacterial biomass, high concentrations of chlorides, dissolved solids, suspended solids, hydrogen sulfide and other products that are obtained from underground water, oil and the like and their omission should not be considered a limitation of this patent. This collection of materials, elements, and compounds often produces a very stable and tight emulsion that is not easily broken.

Chlorine dioxide has been shown to clean produced hydrocarbons and flood water by acting as a biocide. However, chlorine alone is volatile, explosive, and is largely impractical to use due to local, federal, and state transportation and utilization restrictions. Furthermore, the reduction or elimination of polymer structures from produced hydrocarbons and recovered flood water, and/or the reduction of polymer viscosity, is not currently easily performed using current mechanical or chemical means and technologies.

As such, although a number of additives are known in the art, there is a continued need for more effective additives for increasing crude oil or formation gas for wellbore remediation, drilling operations, and formation stimulation.

### SUMMARY OF INVENTION

The present invention generally provides systems, methods, and compositions comprising an emulsion or a microemulsion and chlorine dioxide for use in oil and/or gas wells. In some embodiments, the systems, methods, and/or compositions comprise reducing the viscosity of a fluid comprising a polymer, wherein the fluid was utilized in the recovery of oil and/or gas from the oil and/or gas well.

In some embodiments, a method of treating a fluid used in oil and gas recovery comprises introducing a first composition and a second composition into a fluid wherein the viscosity of the fluid is reduced upon addition of the first composition and the second composition, wherein the fluid comprises water and a polymer, hydrocarbon, or combinations thereof, wherein the first composition comprises chlorine dioxide, and wherein the second composition comprises an emulsion or a microemulsion. Other aspects, embodiments, and features of the invention will become apparent from the following detailed description when considered in conjunction with the accompanying drawings. All patent applications and patents incorporated herein by reference are incorporated by reference in their entirety. In case of conflict, the present specification, including definitions, will control.

### BRIEF DESCRIPTION OF THE DRAWINGS

The accompanying drawings are not intended to be drawn to scale. For purposes of clarity, not every component may be labeled in every drawing. In the drawings:

FIG. 1 shows an exemplary plot for determining the phase inversion temperature of a microemulsion, according to some embodiments.

FIG. 2A shows an exemplary plot for treatment of oil and/or gas wells, according to some embodiments.

FIG. 2B shows an exemplary plot for treatment of an oil and/or gas wellbore, according to some embodiments.

### DETAILED DESCRIPTION

The present invention generally provides systems, methods, and compositions comprising an emulsion or a microemulsion and chlorine dioxide for use in oil and/or gas wells. The systems described herein may be utilized in a number of applications, including, but not limited to water floods, polymer floods, surfactants polymer floods, alkaline surfactant floods, surfactant floods, and other flooding techniques that would be known to those skilled in the art. In some embodiments, the systems, methods, and/or compositions comprise reducing the viscosity of a fluid comprising a polymer, wherein the fluid was utilized in the recovery of oil and/or gas from the oil and/or gas well.

As will be known in the art, various techniques may be utilized in connection with an oil and/or gas well to enhance recovery of oil and/or gas from the well. In some embodiments, the technique comprises polymer flooding, wherein a fluid (e.g., water) comprising a polymer is provided to the well. Polymers for use in polymer flooding processes will be known to those of ordinary skill in the art. In certain embodiments, a polymer may comprise polymers or gellants used in the treatment fluids (e.g., polysaccharide polymers such as guar gum, guar derivatives, biopolymers, cellulose, and its derivatives or synthetic polymers such as polyacrylamide). In some cases, the polymer may be found naturally in a wellbore. In certain embodiments, the hydrocarbon and/or the polymer may comprise asphaltene and/or paraffin.

The fluids recovered from the well and/or present in the well following the polymer flood generally comprises a polymer and/or a polymer gel. The fluid may be collected in above-ground tanks and may further comprise emulsified and/or free hydrocarbons from the well. The free hydrocarbons can generally be extracted from the fluid by simply removing the floating non-emulsified oil. Subsequent steps may be taken to remove the emulsified oil, for example, water emulsion treatment steps may generally include a heat treatment to further remove the oil from the fluid (e.g., water). Following the removal of hydrocarbons, the fluid remaining may comprise high concentrations of various chemicals, including the polymer, polymer gels, and other organic and inorganic compounds.

In some embodiments, it may be beneficial to treat the fluid to alter the properties of the fluid. For example, treating the fluid may breakdown the polymers, polymer gels, and/or other organic and inorganic compounds. In some cases, treating the fluid reduces the viscosity of the fluid (e.g., so that it may be more easily transported or subsequently treated).

In some embodiments, a method of treating a fluid used in oil and gas recovery is provided, wherein the viscosity of the fluid is reduced following treatment. In some embodiments, a first composition and a second composition are introduced into the fluid and the viscosity of the fluid is reduced upon addition of the first composition and the second composition. In some embodiments, the first composition comprises chlorine dioxide. In some embodiments, the second composition comprises an emulsion or a microemulsion. In some embodiments, the viscosity of the fluid is reduced by the cleavage of chemical bonds. In some embodiments, the bond is a covalent bond. In some embodiments, the fluid comprises water and a polymer, and optionally a hydrocarbon (e.g., oil and/or gas). In some embodiments, the viscosity of the fluid is reduced by the cleavage of a polymer backbone. In some embodiments, a covalent bond of a polymer backbone is cleaved.

In some embodiments, a composition is provided to the fluid comprising a first composition comprising chloride dioxide and a second composition comprising an emulsion or a microemulsion. The emulsion or microemulsion may be as described herein (e.g., formed by combining a solvent-surfactant blend with or without alcohols, and with or without a carrier fluid). In some cases, the emulsion or microemulsion may facilitate breakdown of the polymer by means of chlorine dioxide. The composition may be used to reduce the viscosity of polymers in a fluid (e.g., water), wherein the fluid has been utilized in connection with an oil and/or gas well. The viscosity of the polymer, and thus, the resulting fluid is generally accomplished by chemically breaking the polymer backbone in the water. For example, the chlorine dioxide may react with the polymer to breakdown the polymer (e.g., by cleavage of the polymer backbone, via oxidation of the polymer backbone, e.g., via cleavage of a bond in the polymer backbone, etc.), which aids in processing of the fluid. Generally, the more rapidly the water can be processed, the more rapidly it can be reused, and the more rapidly the usable hydrocarbons such as oil can be extracted, which is economically beneficial. Generally, this breakdown process does not necessarily consume 100% of the polymer, but may consume amounts suitable to significantly decrease the viscosity of the water containing the polymer, and thus aid in processability.

In some embodiments, the inventors have found that use of a system comprising chlorine dioxide and an emulsion or microemulsion provides many benefits as compared to use of a system comprising chlorine dioxide or the emulsion or microemulsion alone. For example, the breakdown of the polymer may occur more rapidly, resulting in water that is more favorable to subsequent processing steps in the oil and gas industry. In addition, the addition of an emulsion or microemulsion to chlorine dioxide (e.g., water comprising chlorine dioxide) may remove iron sulfide, mitigate hydrogen sulfide, remove underlying bacteria and bacterial biomass, breakup polymers and gels, and/or eliminate solids carrying agents. Without wishing to be bound by theory, the mixture of an emulsion or microemulsion with chlorine dioxide may promote a series of complexing reactions that do not otherwise occur with emulsions, microemulsions, or chlorine dioxide alone. As an illustrative example, the addition of a microemulsion and chlorine dioxide to a produced fluid stream-treating process immediately broke a very stable, polymer based emulsion whereas neither the microemulsion alone nor chlorine dioxide alone had a significant effect on breaking down the polymer.

As noted above, in some embodiments, a method of treating a fluid used in oil and gas recovery is provided, wherein the viscosity of the fluid is reduced following treatment. As used herein, the term “viscosity” is given its ordinary meaning in the art and refers to the resistance of a fluid to deformation by applied shear or tensile stress. Those of ordinary skill in the art will be aware of methods and techniques for determining a decrease in viscosity of a fluid. For example, the viscosity of a fluid prior to and following introduction of the emulsion or microemulsion and chlorine dioxide may be determined. As a specific non-limiting example, the viscosity of a fluid comprising water and a polymer may be determined. The viscosity of the fluid following introduction of the emulsion or microemulsion and chloride dioxide may also be determined. The difference in the viscosity before and after the introduction may be compared, and the reduction in viscosity determined. As another non-limiting example, laboratory tests may be conducted, to demonstrate the efficacy of the emulsion or microemulsion and chlorine dioxide mixture against samples obtained from actual polymer floods. In some embodiments, following introduction of the emulsion or microemulsion and chlorine dioxide, the fluid is about 1 cp, or between 0.1 cp and about 10 cp, or between about 0.1 cp and about 5 cp, or between about 0.5 cp and about 2 cp. In some embodiments, the viscosity of a fluid is determine at about 20° C., or about 25° C. In some embodiments, the viscosity may be determined using a viscometer.

In some embodiments, following treatment of the fluid with the system (e.g., comprising chlorine dioxide and an emulsion or microemulsion), subsequent oil and water separation occurs and additional oil may be recovered. The fluid comprising the polymer may be exposed to the system post-production (e.g., the fluid with polymer has been removed from the well and is treated externally) and/or in situ (e.g., in the reservoir underground and/or in the well itself).

In some embodiments, an emulsion or microemulsion and chlorine dioxide may be injected into a water disposal well, increasing injection rates and lowering injection pressures. In certain embodiments, an emulsion or microemulsion and chlorine dioxide may be added to remediate oil and gas producing wells to increase the rate at which hydrocarbons are brought to the surface.

The use of an emulsion or microemulsion with chlorine dioxide offers a number of advantages over oxidation technologies currently practiced in the art. Non-limiting examples include improved bactericidal and biomass removal properties as compared to other techniques such as bleach, UV radiation, hydro cavitation, or electro coagulation. For example, in some embodiments, a composition comprising chlorine dioxide and an emulsion or microemulsion, as described herein, has been found to be superior to bleach, elemental chlorine, hypochlorous acid, and other oxidizers. Furthermore, bleach is not known to break the backbone of a polymer, which is critical for adequate polymer treatment. Bleach may also contribute to degradation of the facilities such as steel pipes and other systems that are susceptible to corrosion.

Additional non-limiting examples of the advantages of an emulsion or microemulsion with chlorine dioxide over current oxidation technologies include reduced contact time, reduced dependence on pH, well-developed process control, and/or increased breakdown of polymers. Additionally, the emulsion or microemulsion and chlorine dioxide system is environmentally friendly and may be significantly less costly than other oxidation techniques currently practiced in the art. Other advantages of using the emulsion or microemulsion and chlorine dioxide system include the absence of trihalomethanes (THM), reduced concentration requirements, increased safety, increased reliability, the ability to use generators of large capacity, and/or increased effectiveness for iron and manganese as compared to other oxidation techniques currently practiced in the art.

Any suitable fluid may be treated with the system as described herein (e.g., comprising chlorine dioxide and an emulsion or microemulsion). Generally, the fluid comprises water and/or hydrocarbons. In some embodiments, fluid below the earth's surface (e.g., the well, wellbore, casing, coiled tubing, or others) may be treated with a system, as described herein. In some embodiments, a liquid conveyance (e.g., pipe, pipeline, tubing, coiled tubing, troughs, ditches, or the like) may be treated with the system. In some embodiments, fluid above ground (e.g., liquid storage units including ponds, pits, bermed areas, or any region that is used to contain or hold liquid) may be treated with the system. In some embodiments, the system comprising an emulsion or microemulsion and chlorine dioxide may be added to a liquid conveyance system (e.g., pipe, pipeline, trough, ditch, tube, etc.) to, for example, break down sludge into a solution that can be discharged or reduce the viscosity of a fluid containing a polymer. In some embodiments, the system comprising an emulsion or microemulsion and chlorine dioxide may be added to a liquid containment system (e.g., a pit, pool, pond, etc.) to, for example, reduce the viscosity of a fluid containing a polymer.

In some embodiments, an emulsion or microemulsion may be generated before introduction into the well (e.g., for use near a wellbore cleanout), during introduction into the well, and/or after introduction into the well. In certain embodiments, chlorine dioxide may be generated before introduction into the well, during introduction into the well, and/or after introduction into the well. In other embodiments, generation of the chlorine dioxide and the formation of the emulsion or microemulsion in the fluid may occur substantially simultaneously. The chlorine dioxide and the emulsion or microemulsion may be introduced to the fluid at any suitable time. In some embodiments, the chlorine dioxide and/or emulsion or microemulsion are added to the fluid before introduction of the fluid to a well (e.g., a wellbore). In some cases, the chlorine dioxide and the emulsion or microemulsion are mixed prior to introduction into the fluid. In some cases, the chlorine dioxide and the emulsion or microemulsion may be added to the fluid substantially simultaneously. In some embodiments, the chlorine dioxide and/or emulsion or microemulsion are added to the fluid during addition of the fluid to the well. Alternatively, in some embodiments, the introduction of the chlorine dioxide to the fluid may be separated by some amount of time from the introduction of the emulsion or microemulsion (e.g., the addition of chlorine dioxide during the treatment of a polymer flood, enabling the user to clean the polymer out of the reservoir, followed by the introduction of the emulsion or microemulsion). In some cases, the emulsion or microemulsion is added as a slug to the well prior to introduction of the fluid comprising the chlorine dioxide. In some cases, the emulsion or microemulsion is added to the well after introduction of the chlorine dioxide.

Combinations of the above processes are also possible.

In some embodiments, the fluid is added during a post-production polymer flood when the collection of oil, polymer, water, chemicals and the like are treated in a tank or holding facility or in situ, performed underground or in pipes or pipelines in reservoir stimulation cleanout or similar non-above ground applications. In certain embodiments, the fluid is added to gathering lines, facilities, pipelines, tank cleanouts, and/or the like.

Details regarding the system comprising chlorine dioxide and an emulsion or microemulsion will now be provided. In some embodiments, the system comprises a first composition comprising chlorine dioxide and a second composition comprises an emulsion or a microemulsion. In certain embodiments, the composition comprising the first composition and the second composition are added to a fluid. The fluid may be, for example, a fluid recovered from a well (e.g., a fluid comprising water and/or a hydrocarbon stored in an above-ground tank). In some cases, the fluid may be a fluid added to a well (e.g., a stimulation fluid utilized during a polymer flood). In some embodiments, the system comprises the emulsion or microemulsion in an amount between about 0.1 and about 50 gallons per thousand gallons of the fluid (“gpt”), or between about 2 and about 20, or between about 2 and about 10, or between about 0.5 and about 10 gpt, or between about 2 and about 5, or between about 5 and about 10, or between about 0.5 and about 2 gpt. In some embodiments, the system comprises chlorine dioxide in an amount between about 1 and about 15,000 ppm, between about 1 and about 10,000 ppm, or between about 100 and about 5,000 ppm, or between about 1,000 and about 5,000 ppm, or between about 2,000 and about 5,000 ppm. In some cases, the emulsion or microemulsion is present in an amount between about 2 and about 20 gpt and the chlorine dioxide is present in an about between about 1 and 15,000 ppm the fluid. In some cases, the emulsion or microemulsion is present in an amount between about 1 and about 10 gpt and the chlorine dioxide is present in an about between about 1,000 and 5,000 ppm.

Chlorine dioxide has been shown to clean produced fluids and injection water via oxidation. For example, chlorine dioxide may oxidize polyacrylamide polymer residue, iron sulfide (FeS), hydrogen sulfide (H₂S), bacteria and bacterial biomass, but these examples are not intended to limit the scope of the invention. Chlorine dioxide, as described herein, also assist in the removal of FeS, H₂S, emulsions and sludge, and polymer damage. For example, chlorine dioxide may be effective at mitigating the effects of and/or removing sulfur compounds (e.g., sulfur, hydrogen sulfide, hydrosulfide, sulfide ions, iron sulfide), nitrogen compounds (e.g., ammonia, ammonium salts, hydrogen cyanide, metal cyanides, cyano complexes, cyanates, nitrites, nitrates, nitrogen oxides), inorganic ions (e.g., ferrous ions, manganous ions), reactive organic compounds (e.g., aromatic hydrocarbons, unsaturated hydrocarbons, alcohols, aldehydes, carbohydrates, organic sulfurs (e.g., mercaptans, disulfides), phenols, amines, polymers (e.g., guar gels, polacryamide), emulsifiers), and non-reactive organic compounds (e.g., saturated aliphatic hydrocarbons, aromatic hydrocarbons, carboxylic acids, amino acids, nitro aromatics).

In some embodiments, the chlorine dioxide (or chlorine to produce chlorine dioxide) may be provided directly. However, in some embodiments, due to the dangerous, volatile, and explosive nature of chlorine and/or chlorine dioxide, the chlorine dioxide may be generated in situ and/or on site. Installed, non-transportation based chlorine dioxide water treating technology is commoditized across multiple industries, including drinking water and cooling towers. Chlorine dioxide generation systems are commercially available and will be known to those or ordinary skill in the art. For example, non-limiting examples of systems to produce chlorine dioxide include the use of a two chemical precursor system, a three chemical precursor system, or others methods known by those skilled in the art. In some embodiments, the three chemical precursor system comprises sodium chlorite (NaClO₂, e.g., 25% wt. solution), sodium hypochlorite (NaOCl, e.g. 12.5% wt. solution), and hydrochloric acid (HCl, e.g., 15% wt. solution), in water which yields chlorine dioxide (e.g. in a range of between about 1 ppm and about 15,000 ppm of chlorine dioxide in water). In some embodiments, the two chemical precursor system comprises sodium chlorite and hydrochloric acid. In some embodiments, the chemical precursor system comprises a secondary treatment. In certain embodiments, an electrical system may be used. In some embodiments, the electrical system may comprise saltwater and/or other synthetic chemicals. Other methods for generating chlorine dioxide are also possible and will be known in the art.

In some embodiments, chlorine dioxide is gaseous chlorine dioxide. In some embodiments, chlorine dioxide is liquid chlorine dioxide. In certain embodiments, chlorine dioxide may be contained within a micelle. In some embodiments, chlorine dioxide may be contained within a carrier fluid. In certain embodiments, a carrier fluid may include one or more of water, a hydrocarbon (e.g., propane or butane), a liquid phase material, and a gaseous phase material. In some embodiments, the liquid phase material may comprise liquid carbon dioxide, liquid nitrogen, liquid air, or the like. In certain embodiments, the gas phase material may be gaseous carbon dioxide, gaseous nitrogen, air, or the like. Other liquid phase and gas phase materials are also possible.

In some embodiments, the system comprises an emulsion or a microemulsion. The terms should be understood to include emulsions or microemulsions that have a water continuous phase, or that have an oil continuous phase, or microemulsions that are bicontinuous.

As used herein, the term emulsion is given its ordinary meaning in the art and refers to dispersions of one immiscible liquid in another, in the form of droplets, with diameters approximately in the range of 100 1,000 nanometers. Emulsions may be thermodynamically unstable and/or require high shear forces to induce their formation.

As used herein, the term microemulsion is given its ordinary meaning in the art and refers to dispersions of one immiscible liquid in another, in the form of droplets, with diameters approximately in the range of about between about 1 and about 1000 nm, or between 10 and about 1000 nanometers, or between about 10 and about 500 nm, or between about 10 and about 300 nm, or between about 10 and about 100 nm. Microemulsions are clear or transparent because they contain particles smaller than the wavelength of visible light. In addition, microemulsions are homogeneous thermodynamically stable single phases, and form spontaneously, and thus, differ markedly from thermodynamically unstable emulsions, which generally depend upon intense mixing energy for their formation. Microemulsions may be characterized by a variety of advantageous properties including, by not limited to, (i) clarity, (ii) very small particle size, (iii) ultra-low interfacial tensions, (iv) the ability to combine properties of water and oil in a single homogeneous fluid, (v) shelf life stability, and (vi) ease of preparation.

In some embodiments, the microemulsions described herein are stabilized microemulsions that are formed by the combination of a solvent-surfactant blend with an appropriate oil-based or water-based carrier fluid. Generally, the microemulsion forms upon simple mixing of the components without the need for high shearing generally required in the formation of ordinary emulsions. In some embodiments, the microemulsion is a thermodynamically stable system, and the droplets remain finely dispersed over time. In some cases, the average droplet size ranges from about 10 nm to about 300 nm.

It should be understood, that while much of the description herein focuses on microemulsions, this is by no means limiting, and emulsions may be employed where appropriate.

In some embodiments, the emulsion or microemulsion is a single emulsion or microemulsion. For example, the emulsion or microemulsion comprises a single layer of a surfactant. In other embodiments, the emulsion or microemulsion may be a double or multilamellar emulsion or microemulsion. For example, the emulsion or microemulsion comprises two or more layers of a surfactant. In some embodiments, the emulsion or microemulsion comprises a single layer of surfactant surrounding a core (e.g., one or more of water, oil, solvent, and/or other additives) or a multiple layers of surfactant (e.g., two or more concentric layers surrounding the core). In certain embodiments, the emulsion or microemulsion comprises two or more immiscible cores (e.g., one or more of water, oil, solvent, and/or other additives which have equal or about equal affinities for the surfactant).

In some embodiments, a microemulsion comprises water, a solvent, and a surfactant. In some embodiments, the microemulsion further comprises additional components, for example, a freezing point depression agent. Details of each of the components of the microemulsions are described in detail herein. In some embodiments, the components of the microemulsions are selected so as to reduce or eliminate the hazards of the microemulsion to the environment and/or the subterranean reservoirs. The microemulsion generally comprises a solvent and an aqueous phase. The solvent, or a combination of solvents, may be present in the microemulsion in any suitable amount. In some embodiments, the total amount of solvent present in the microemulsion is between about 2 wt % and about 60 wt %, or between about 5 wt % and about 40 wt %, or between about 5 wt % and about 30 wt %, versus the total microemulsion composition. Those of ordinary skill in the art will appreciate that emulsions or microemulsions comprising more than two types of solvents may be utilized in the methods, compositions, and systems described herein. For example, the microemulsion may comprise more than one or two types of solvent, for example, three, four, five, six, or more, types of solvents. In some embodiments, the emulsion or microemulsion comprises a first type of solvent and a second type of solvent. The first type of solvent to the second type of solvent ratio in a microemulsion may be present in any suitable ratio. In some embodiments, the ratio of the first type of solvent to the second type of solvent is between about 4:1 and 1:4, or between 2:1 and 1:2, or about 1:1.

The aqueous phase to solvent ratio in a emulsion or microemulsion may be varied. In some embodiments, the ratio of water to solvent, along with other parameters of the solvent, may be varied so that displacement of residual aqueous treatment fluid by formation gas and/or formation crude is preferentially stimulated. In some embodiments, the ratio of aqueous phase to solvent is between about 15:1 and 1:10, or between 9:1 and 1:4, or between 3.2:1 and 1:4.

In some embodiments, the solvent is selected from the group consisting of unsubstituted cyclic or acyclic, branched or unbranched alkanes having 6-12 carbon atoms, unsubstituted acyclic branched or unbranched alkenes having one or two double bonds and 6-12 carbon atoms, cyclic or acyclic, branched or unbranched alkanes having 9-12 carbon atoms and substituted with only an —OH group, branched or unbranched dialkylether compounds having the formula CₙH₂ₙ₊₁OCₘH₂ₘ₊₁, wherein n+m is between 6 and 16, and aromatic solvents having a boiling point between about 300-400° F.

In some embodiments, the solvent is an unsubstituted cyclic or acyclic, branched or unbranched alkane having 6-12 carbon atoms. In some embodiments, the cyclic or acyclic, branched or unbranched alkane has 6-10 carbon atoms. Non-limiting examples of unsubstituted acyclic unbranched alkanes having 6-12 carbon atoms include hexane, heptane, octane, nonane, decane, undecane, and dodecane. Non-limiting examples of unsubstituted acyclic branched alkanes having 6-12 carbon atoms include isomers of methylpentane (e.g., 2-methylpentane, 3-methylpentane), isomers of dimethylbutane (e.g., 2,2-dimethylbutane, 2,3-dimethylbutane), isomers of methylhexane (e.g., 2-methylhexane, 3-methylhexane), isomers of ethylpentane (e.g., 3-ethylpentane), isomers of dimethylpentane (e.g., 2,2,-dimethylpentane, 2,3-dimethylpentane, 2,4-dimethylpentane, 3,3-dimethylpentane), isomers of trimethylbutane (e.g., 2,2,3-trimethylbutane), isomers of methylheptane (e.g., 2-methylheptane, 3-methylheptane, 4-methylheptane), isomers of dimethylhexane (e.g., 2,2-dimethylhexane, 2,3-dimethylhexane, 2,4-dimethylhexane, 2,5-dimethylhexane, 3,3-dimethylhexane, 3,4-dimethylhexane), isomers of ethylhexane (e.g., 3-ethylhexane), isomers of trimethylpentane (e.g., 2,2,3-trimethylpentane, 2,2,4-trimethylpentane, 2,3,3-trimethylpentane, 2,3,4-trimethylpentane), and isomers of ethylmethylpentane (e.g., 3-ethyl-2-methylpentane, 3-ethyl-3-methylpentane). Non-limiting examples of unsubstituted cyclic branched or unbranched alkanes having 6-12 carbon atoms, include cyclohexane, methylcyclopentane, ethylcyclobutane, propylcyclopropane, isopropylcyclopropane, dimethylcyclobutane, cycloheptane, methylcyclohexane, dimethylcyclopentane, ethylcyclopentane, trimethylcyclobutane, cyclooctane, methylcycloheptane, dimethylcyclohexane, ethylcyclohexane, cyclononane, methylcyclooctane, dimethylcycloheptane, ethylcycloheptane, trimethylcyclohexane, ethylmethylcyclohexane, propylcyclohexane, and cyclodecane. In a particular embodiment, the unsubstituted cyclic or acyclic, branched or unbranched alkane having 6-12 carbon is selected from the group consisting of heptane, octane, nonane, decane, 2,2,4-trimethylpentane (isooctane), and propylcyclohexane.

In some embodiments, the solvent is an unsubstituted acyclic branched or unbranched alkene having one or two double bonds and 6-12 carbon atoms. In some embodiments, the solvent is an unsubstituted acyclic branched or unbranched alkene having one or two double bonds and 6-10 carbon atoms. Non-limiting examples of unsubstituted acyclic unbranched alkenes having one or two double bonds and 6-12 carbon atoms include isomers of hexene (e.g., 1-hexene, 2-hexene), isomers of hexadiene (e.g., 1,3-hexadiene, 1,4-hexadiene), isomers of heptene (e.g., 1-heptene, 2-heptene, 3-heptene), isomers of heptadiene (e.g., 1,5-heptadiene, 1-6, heptadiene), isomers of octene (e.g., 1-octene, 2-octene, 3-octene), isomers of octadiene (e.g., 1,7-octadiene), isomers of nonene, isomers of nonadiene, isomers of decene, isomers of decadiene, isomers of undecene, isomers of undecadiene, isomers of dodecene, and isomers of dodecadiene. In some embodiments, the acyclic unbranched alkene having one or two double bonds and 6-12 carbon atoms is an alpha-olefin (e.g., 1-hexene, 1-heptene, 1-octene, 1-nonene, 1-decene, 1-undecene, 1-dodecene). Non-limiting examples unsubstituted acyclic branched alkenes include isomers of methylpentene, isomers of dimethylpentene, isomers of ethylpentene, isomers of methylethylpentene, isomers of propylpentene, isomers of methylhexene, isomers of ethylhexene, isomers of dimethylhexene, isomers of methylethylhexene, isomers of methylheptene, isomers of ethylheptene, isomers of dimethylhexptene, and isomers of methylethylheptene. In a particular embodiment, the unsubstituted acyclic unbranched alkene having one or two double bonds and 6-12 carbon atoms is selected from the group consisting of 1-octene and 1,7-octadiene.

In some embodiments, the solvent is a cyclic or acyclic, branched or unbranched alkane having 9-12 carbon atoms and substituted with only an —OH group. Non-limiting examples of cyclic or acyclic, branched or unbranched alkanes having 9-12 carbon atoms and substituted with only an —OH group include isomers of nonanol, isomers of decanol, isomers of undecanol, and isomers of dodecanol. In a particular embodiment, the cyclic or acyclic, branched or unbranched alkane having 9-12 carbon atoms and substituted with only an —OH group is selected from the group consisting of 1-nonanol and 1-decanol.

In some embodiments, the solvent is a branched or unbranched dialkylether compound having the formula CₙH₂ₙ₊₁OCₘH₂ₘ₊₁ wherein n+m is between 6 and 16. In some cases, n+m is between 6 and 12, or between 6 and 10, or between 6 and 8. Non-limiting examples of branched or unbranched dialkylether compounds having the formula CₙH₂ₙ₊₁OCₘH₂ₘ₊₁ include isomers of C₃H₇OC₃H₇, isomers of C₄H₉OC₃H₇, isomers of C₅H₁₁OC₃H₇, isomers of C₆H₁₃OC₃H₇, isomers of C₄H₉OC₄H₉, isomers of C₄H₉OC₅H₁₁, isomers of C₄H₉OC₆H₁₃, isomers of C₅H₁₁OC₆H₁₃, and isomers of C₆H₁₃OC₆H₁₃. In a particular embodiment, the branched or unbranched dialkylether is an isomer C₆H₁₃OC₆H₁₃ (e.g., dihexylether).

In some embodiments, the solvent is an aromatic solvent having a boiling point between about 300-400° F. Non-limiting examples of aromatic solvents having a boiling point between about 300-400° F. include butylbenzene, hexylbenzene, mesitylene, light aromatic naphtha, and heavy aromatic naphtha.

In other embodiments, when displacement of residual aqueous treatment fluid by formation gas is preferentially stimulated, the solvent is selected from the group consisting of cyclic or acyclic, branched or unbranched alkanes having 8 carbon atoms and substituted only with an —OH group and aromatic solvents having a boiling point between about 175-300° F.

In some embodiments, the solvent is a cyclic or acyclic, branched or unbranched alkane having 8 carbon atoms and substituted with only an —OH group. Non-limiting examples of cyclic or acyclic, branched or unbranched alkanes having 8 carbon atoms and substituted with only an —OH group include isomers of octanol (e.g., 1-octanol, 2-octanol, 3-octanol, 4-octanol), isomers of methyl heptanol, isomers of ethylhexanol (e.g., 2-ethyl-1-hexanol, 3-ethyl-1-hexanol, 4-ethyl-1-hexanol), isomers of dimethylhexanol, isomers of propylpentanol, isomers of methylethylpentanol, and isomers of trimethylpentanol. In a particular embodiment, the cyclic or acyclic, branched or unbranched alkane having 8 carbon atoms and substituted with only an —OH group is selected from the group consisting of 1-octanol and 2-ethyl-1-hexanol.

In some embodiments, the solvent is an aromatic solvent having a boiling point between about 175-300° F. Non-limiting examples of aromatic liquid solvents having a boiling point between about 175-300° F. include benzene, xylenes, and toluene. In a particular embodiment, the solvent is not xylene.

In some embodiments, the microemulsion In some embodiments, the solvent is a terpene or a terpenoid. In some embodiments, the terpene or terpenoid comprises a first type of terpene or terpenoid and a second type of terpene or terpenoid. Terpenes may be generally classified as monoterpenes (e.g., having two isoprene units), sesquiterpenes (e.g., having 3 isoprene units), diterpenes, or the like. The term terpenoid also includes natural degradation products, such as ionones, and natural and synthetic derivatives, e.g., terpene alcohols, aldehydes, ketones, acids, esters, epoxides, and hydrogenation products (e.g., see Ullmann's Encyclopedia of Industrial Chemistry, 2012, pages 29-45, herein incorporated by reference). It should be understood, that while much of the description herein focuses on terpenes, this is by no means limiting, and terpenoids may be employed where appropriate. In some cases, the terpene is a naturally occurring terpene. In some cases, the terpene is a non-naturally occurring terpene and/or a chemically modified terpene (e.g., saturated terpene, terpene amine, fluorinated terpene, or silylated terpene).

In some embodiments, the terpene is a monoterpene. Monoterpenes may be further classified as acyclic, monocyclic, and bicyclic (e.g., with a total number of carbons in the range between 18-20), as well as whether the monoterpene comprises one or more oxygen atoms (e.g., alcohol groups, ester groups, carbonyl groups, etc.). In some embodiments, the terpene is an oxygenated terpene, for example, a terpene comprising an alcohol, an aldehyde, and/or a ketone group. In some embodiments, the terpene comprises an alcohol group. Non-limiting examples of terpenes comprising an alcohol group are linalool, geraniol, nopol, α-terpineol, and menthol. In some embodiments, the terpene comprises an ether-oxygen, for example, eucalyptol, or a carbonyl oxygen, for example, menthone. In some embodiments, the terpene does not comprise an oxygen atom, for example, d-limonene.

Non-limiting examples of terpenes include linalool, geraniol, nopol, α-terpineol, menthol, eucalyptol, menthone, d-limonene, terpinolene, β-occimene, γ-terpinene, α-pinene, and citronellene. In a particular embodiment, the terpene is selected from the group consisting of α-terpeneol, α-pinene, nopol, and eucalyptol. In one embodiment, the terpene is nopol. In another embodiment, the terpene is eucalyptol. In some embodiments, the terpene is not limonene (e.g., d-limonene). In some embodiments, the emulsion is free of limonene.

In some embodiments, the terpene is a non-naturally occurring terpene and/or a chemically modified terpene (e.g., saturated terpene). In some cases, the terpene is a partially or fully saturated terpene (e.g., p-menthane, pinane). In some cases, the terpene is a non-naturally occurring terpene. Non-limiting examples of non-naturally occurring terpenes include, menthene, p-cymene, r-carvone, terpinenes (e.g., alpha-terpinenes, beta-terpinenes, gamma-terpinenes), dipentenes, terpinolenes, borneol, alpha-terpinamine, and pine oils.

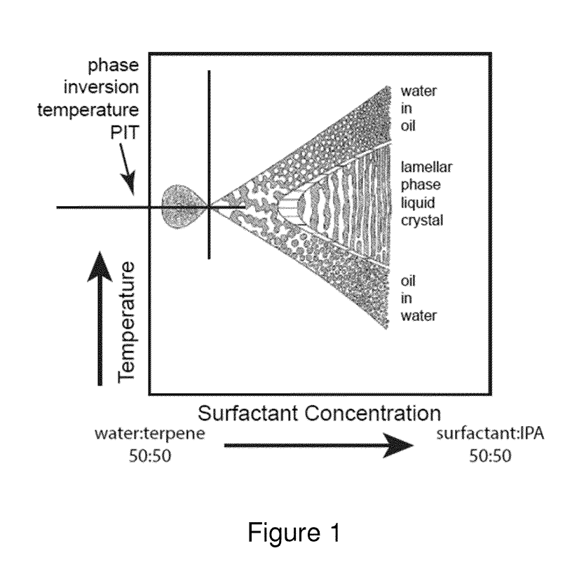

In some embodiments, the terpene may be classified in terms of its phase inversion temperature (“PIT”). The term “phase inversion temperature” is given its ordinary meaning in the art and refers to the temperature at which an oil in water microemulsion inverts to a water in oil microemulsion (or vice versa). Those of ordinary skill in the art will be aware of methods for determining the PIT for a microemulsion comprising a terpene (e.g., see Strey, Colloid & Polymer Science, 1994. 272(8): p. 1005-1019; Kahlweit et al., Angewandte Chemie International Edition in English, 1985. 24(8): p. 654-668). The PIT values described herein were determined using a 1:1 ratio of terpene (e.g., one or more terpenes):de-ionized water and varying amounts (e.g., between about 20 wt % and about 60 wt %; generally, between 3 and 9 different amounts are employed) of a 1:1 blend of surfactant comprising linear C₁₂-C₁₅ alcohol ethoxylates with on average 7 moles of ethylene oxide (e.g., Neodol 25-7):isopropyl alcohol wherein the upper and lower temperature boundaries of the microemulsion region can be determined and a phase diagram may be generated. Those of ordinary skill in the art will recognize that such a phase diagram (e.g., a plot of temperature against surfactant concentration at a constant oil-to-water ratio) may be referred to as “fish” diagram or a Kahlweit plot. The temperature at the vertex is the PIT. An exemplary fish diagram indicating the PIT is shown in FIG. 1. PITs for non-limiting examples of terpenes determined using this experimental procedure outlined above are given in Table 1.

TABLE 1
Phase inversion temperatures for non-limiting examples of terpenes.

| Terpene | Phase Inversion Temperature ° F. (° C.) |
|---|---|
| linalool | 24.8 (−4) |
| geraniol | 31.1 (−0.5) |
| nopol | 36.5 (2.5) |
| α-terpineol | 40.3 (4.6) |
| menthol | 60.8 (16) |
| eucalyptol | 87.8 (31) |
| menthone | 89.6 (32) |
| d-limonene | 109.4 (43) |
| terpinolene | 118.4 (48) |
| β-occimene | 120.2 (49) |
| γ-terpinene | 120.2 (49) |
| α-pinene | 134.6 (57) |
| citronellene | 136.4 (58) |

In certain embodiments, the solvent utilized in the emulsion or microemulsion herein may comprise one or more impurities. For example, in some embodiments, a solvent (e.g., a terpene) is extracted from a natural source (e.g., citrus, pine), and may comprise one or more impurities present from the extraction process. In some embodiment, the solvent comprises a crude cut (e.g., uncut crude oil, for example, made by settling, separation, heating, etc.). In some embodiments, the solvent is a crude oil (e.g., naturally occurring crude oil, uncut crude oil, crude oil extracted from the wellbore, synthetic crude oil, crude citrus oil, crude pine oil, eucalyptus, etc.). In some embodiments, the solvent is a citrus extract (e.g., crude orange oil, orange oil, etc.).

In some embodiments, at least one of the solvents comprised in the emulsion or microemulsion comprising a mutual solvent which is miscible together with the water and the solvent. In some embodiments, the mutual solvent is present in an amount between about at 0.5 wt % to about 30% of mutual solvent. Non-limiting examples of suitable mutual solvents include ethyleneglycolmonobutyl ether (EGMBE), dipropylene glycol monomethyl ether, short chain alcohols (e.g., isopropanol), tetrahydrofuran, dioxane, dimethylformamide, and dimethylsulfoxide.

Generally, the microemulsion comprises an aqueous phase. Generally, the aqueous phase comprises water. The water may be provided from any suitable source (e.g., sea water, fresh water, deionized water, reverse osmosis water, water from field production). The water may be present in any suitable amount. In some embodiments, the total amount of water present in the microemulsion is between about 1 wt % about 95 wt %, or between about 1 wt % about 90 wt %, or between about 1 wt % and about 60 wt %, or between about 5 wt % and about 60 wt % or between about 10 and about 55 wt %, or between about 15 and about 45 wt %, versus the total microemulsion composition.

In some embodiments, the microemulsion comprises a surfactant. The microemulsion may comprise a single surfactant or a combination of two or more surfactants. For example, in some embodiments, the surfactant comprises a first type of surfactant and a second type of surfactant. The term “surfactant,” as used herein, is given its ordinary meaning in the art and refers to compounds having an amphiphilic structure which gives them a specific affinity for oil/water-type and water/oil-type interfaces which helps the compounds to reduce the free energy of these interfaces and to stabilize the dispersed phase of a microemulsion. The term surfactant encompasses cationic surfactants, anionic surfactants, amphoteric surfactants, nonionic surfactants, zwitterionic surfactants, and mixtures thereof. In some embodiments, the surfactant is a nonionic surfactant. Nonionic surfactants generally do not contain any charges. Amphoteric surfactants generally have both positive and negative charges, however, the net charge of the surfactant can be positive, negative, or neutral, depending on the pH of the solution. Anionic surfactants generally possess a net negative charge. Cationic surfactants generally possess a net positive charge. Zwitterionic surfactants are generally not pH dependent. A zwitterion is a neutral molecule with a positive and a negative electrical charge, though multiple positive and negative charges can be present. Zwitterions are distinct from dipole, at different locations within that molecule.

In some embodiments, the surfactant is an amphiphilic block copolymer where one block is hydrophobic and one block is hydrophilic. In some cases, the total molecular weight of the polymer is greater than 5000 daltons. The hydrophilic block of these polymers can be nonionic, anionic, cationic, amphoteric, or zwitterionic.

Those of ordinary skill in the art will be aware of methods and techniques for selecting surfactants for use in the microemulsions described herein. In some cases, the surfactant(s) are matched to and/or optimized for the particular oil or solvent in use. In some embodiments, the surfactant(s) are selected by mapping the phase behavior of the microemulsion and choosing the surfactant(s) that gives the desired range of phase behavior. In some cases, the stability of the microemulsion over a wide range of temperatures is targeted as the microemulsion may be subject to a wide range of temperatures due to the environmental conditions present at the subterranean formation and/or reservoir.

Suitable surfactants for use with the compositions and methods described herein will be known in the art. In some embodiments, the surfactant is an alkyl polyglycol ether, for example, having 2-40 ethylene oxide (EO) units and alkyl groups of 4-20 carbon atoms. In some embodiments, the surfactant is an alkylaryl polyglycol ether having 2-40 EO units and 8-20 carbon atoms in the alkyl and aryl groups. In some embodiments, the surfactant is an ethylene oxide/propylene oxide (EO/PO) block copolymer having 8-40 EO or PO units. In some embodiments, the surfactant is a fatty acid polyglycol ester having 6-24 carbon atoms and 2-40 EO units. In some embodiments, the surfactant is a polyglycol ether of hydroxyl-containing triglycerides (e.g., castor oil). In some embodiments, the surfactant is an alkylpolyglycoside of the general formula R″—O-Zₙ, where R″ denotes a linear or branched, saturated or unsaturated alkyl group having on average 8-24 carbon atoms and Zₙ denotes an oligoglycoside group having on average n=1-10 hexose or pentose units or mixtures thereof. In some embodiments, the surfactant is a fatty ester of glycerol, sorbitol, or pentaerythritol. In some embodiments, the surfactant is an amine oxide (e.g., dodecyldimethylamine oxide). In some embodiments, the surfactant is an alkyl sulfate, for example having a chain length of 8-18 carbon atoms, alkyl ether sulfates having 8-18 carbon atoms in the hydrophobic group and 1-40 ethylene oxide (EO) or propylene oxide (PO) units. In some embodiments, the surfactant is a sulfonate, for example, an alkyl sulfonate having 8-18 carbon atoms, an alkylaryl sulfonate having 8-18 carbon atoms, an ester or half ester of sulfosuccinic acid with monohydric alcohols or alkylphenols having 4-15 carbon atoms. In some cases, the alcohol or alkylphenol can also be ethoxylated with 1-40 EO units. In some embodiments, the surfactant is an alkali metal salt or ammonium salt of a carboxylic acid or poly(alkylene glycol) ether carboxylic acid having 8-20 carbon atoms in the alkyl, aryl, alkaryl or aralkyl group and 1-40 EO or PO units. In some embodiments, the surfactant is a partial phosphoric ester or the corresponding alkali metal salt or ammonium salt, e.g. an alkyl and alkaryl phosphate having 8-20 carbon atoms in the organic group, an alkylether phosphate or alkarylether phosphate having 8-20 carbon atoms in the alkyl or alkaryl group and 1-40 EO units. In some embodiments, the surfactant is a salt of primary, secondary, or tertiary fatty amine having 8-24 carbon atoms with acetic acid, sulfuric acid, hydrochloric acid, and phosphoric acid. In some embodiments, the surfactant is a quaternary alkyl- and alkylbenzylammonium salt, whose alkyl groups have 1-24 carbon atoms (e.g., a halide, sulfate, phosphate, acetate, or hydroxide salt).

In some embodiments, the surfactant is an alkylpyridinium, an alkylimidazolinium, or an alkyloxazolinium salt whose alkyl chain has up to 18 carbons atoms (e.g., a halide, sulfate, phosphate, acetate, or hydroxide salt). In some embodiments, the surfactant is amphoteric, including sultaines (e.g., cocamidopropyl hydroxysultaine), betaines (e.g., cocamidopropyl betaine), or phosphates (e.g., lecithin). Non-limiting examples of specific surfactants include a linear C₁₂-C₁₅ ethoxylated alcohols with 5-12 moles of EO, lauryl alcohol ethoxylate with 4-8 moles of EO, nonyl phenol ethoxylate with 5-9 moles of EO, octyl phenol ethoxylate with 5-9 moles of EO, tridecyl alcohol ethoxylate with 5-9 moles of EO, Pluronic® matrix of EO/PO copolymers, ethoxylated cocoamide with 4-8 moles of EO, ethoxylated coco fatty acid with 7-11 moles of EO, and cocoamidopropyl amine oxide.

In some embodiments, the surfactant is a Gemini surfactant. Gemini surfactants generally have the structure of multiple amphiphilic molecules linked together by one or more covalent spacers. In some embodiments, the surfactant is an extended surfactant, wherein the extended surfactants has the structure where a non-ionic hydrophilic spacer (e.g. ethylene oxide or propylene oxide) connects an ionic hydrophilic group (e.g. carboxylate, sulfate, phosphate).

In some embodiments the surfactant is an alkoxylated polyimine with a relative solubility number (RSN) in the range of 5-20. As will be known to those of ordinary skill in the art, RSN values are generally determined by titrating water into a solution of surfactant in 1,4-dioxane. The RSN values is generally defined as the amount of distilled water necessary to be added to produce persistent turbidity. In some embodiments the surfactant is an alkoxylated novolac resin (also known as a phenolic resin) with a relative solubility number in the range of 5-20. In some embodiments the surfactant is a block copolymer surfactant with a total molecular weight greater than 5000 daltons. The block copolymer may have a hydrophobic block that is comprised of a polymer chain that is linear, branched, hyperbranched, dendritic or cyclic. Non-limiting examples of monomeric repeat units in the hydrophobic chains of block copolymer surfactants are isomers of acrylic, methacrylic, styrenic, isoprene, butadiene, acrylamide, ethylene, propylene and norbornene. The block copolymer may have a hydrophilic block that is comprised of a polymer chain that is linear, branched, hyper branched, dendritic or cyclic. Non-limiting examples of monomeric repeat units in the hydrophilic chains of the block copolymer surfactants are isomers of acrylic acid, maleic acid, methacrylic acid, ethylene oxide, and acrylamine.

Those of ordinary skill in the art will be aware of methods and techniques for selecting surfactants for use in the microemulsions described herein. In some cases, the surfactant(s) are matched to and/or optimized for the particular oil or solvent in use. In some embodiments, the surfactant(s) are selected by mapping the phase behavior of the microemulsion and choosing the surfactant(s) that gives the desired range of stability. In some cases, the stability of the microemulsion over a wide range of temperatures is targeted as the microemulsion may be subject to a wide range of temperatures due to the environmental conditions present at the subterranean formation.

The surfactant may be present in the microemulsion in any suitable amount. In some embodiments, the surfactant is present in an amount between about 10 wt % and about 60 wt %, or between about 15 wt % and about 55 wt % versus the total microemulsion composition, or between about 20 wt % and about 50 wt %, versus the total microemulsion composition.

In some embodiments, the microemulsion comprises a freezing point depression agent. The microemulsion may comprise a single freezing point depression agent or a combination of two or more freezing point depression agents. For example, in some embodiments, the freezing point depression agent comprises a first type of freezing point depression agent and a second type of freezing point depression agent. The term “freezing point depression agent” is given its ordinary meaning in the art and refers to a compound which is added to a solution to reduce the freezing point of the solution. That is, a solution comprising the freezing point depression agent has a lower freezing point as compared to an essentially identical solution not comprising the freezing point depression agent. Those of ordinary skill in the art will be aware of suitable freezing point depression agents for use in the microemulsions described herein. Non-limiting examples of freezing point depression agents include primary, secondary, and tertiary alcohols with between 1 and 20 carbon atoms. In some embodiments, the alcohol comprises at least 2 carbon atoms, alkylene glycols including polyalkylene glycols, and salts. Non-limiting examples of alcohols include methanol, ethanol, i-propanol, n-propanol, t-butanol, n-butanol, n-pentanol, n-hexanol, and 2-ethyl-hexanol. In some embodiments, the freezing point depression agent is not methanol (e.g., due to toxicity). Non-limiting examples of alkylene glycols include ethylene glycol (EG), polyethylene glycol (PEG), propylene glycol (PG), and triethylene glycol (TEG). In some embodiments, the freezing point depression agent is not ethylene oxide (e.g., due to toxicity). Non-limiting examples of salts include salts comprising K, Na, Br, Cr, Cr, Cs, or Bi, for example, halides of these metals, including NaCl, KCl, CaCl₂, and MgCl. In some embodiments, the freezing point depression agent comprises an alcohol and an alkylene glycol. Another non-limiting example of a freezing point depression agent is a combination of choline chloride and urea. In some embodiments, the microemulsion comprising the freezing point depression agent is stable over a wide range of temperatures, for example, between about −50° F. and about 200° F. In certain embodiments, the microemulsion comprising the freezing point depression agent is between about −25° F. and about 150° F.

The freezing point depression agent may be present in the microemulsion in any suitable amount. In some embodiments, the freezing point depression agent is present in an amount between about 1 wt % and about 40 wt %, or between about 3 wt % and about 20 wt %, or between about 8 wt % and about 16 wt %, versus the total microemulsion composition.

It should be understood that in embodiments where an emulsion or microemulsion and chlorine dioxide are added to a fluid, that the mixture may be diluted and/or combined with a third composition prior to and/or during use. In some embodiments, the mixture may be combined with ferric chloride (FeCl₃), EDTA (Ethylenediaminetetraacetic acid), biocide, chelating agents, proppants, acids, breakers, and the like, prior to and/or during use.

It may be advantageous, in some cases, to combine a mixture comprising an emulsion or microemulsion and/or chlorine dioxide with a proppant (e.g., to assist in maintaining a fracture open after high pressure subsides when treatment is complete). Non-limiting examples of proppants (e.g., propping agents) include grains of sand, glass beads, crystalline silica (e.g., Quartz), hexamethylenetetramine, ceramic proppants (e.g., calcined clays), resin coated sands, and resin coated ceramic proppants. Other proppants are also possible and will be known to those skilled in the art.

In some embodiments, the third composition comprises a biocide. Non-limiting examples of biocides include didecyl dimethyl ammonium chloride, gluteral, Dazomet, bronopol, tributyl tetradecyl phosphonium chloride, tetrakis(hydroxymethyl)phosphonium sulfate, AQUCAR™, UCARCIDE™, glutaraldehyde, sodium hypochlorite, and sodium hydroxide. Other biocides are also possible and will be known to those skilled in the art.

In certain embodiments, the third composition comprises a scale inhibitor. Non-limiting examples of scale inhibitors include one or more of methyl alcohol, organic phosphonic acid salts (e.g., phosphonate salt), polyacrylate, ethane-1,2-diol, calcium chloride, and sodium hydroxide. Other scale inhibitors are also possible and will be known to those skilled in the art.

In some embodiments, the third composition comprises a buffer. Non-limiting examples of buffers include acetic acid, acetic anhydride, potassium hydroxide, sodium hydroxide, and sodium acetate. Other buffers are also possible and will be known to those skilled in the art.

In certain embodiments, the third composition comprises a corrosion inhibitor. Non-limiting examples of corrosion inhibitors include isopropanol, quaternary ammonium compounds, thiourea/formaldehyde copolymers, propargyl alcohol, cinnamic aldehyde and its derivatives, and methanol. Other corrosion inhibitors are also possible and will be known to those skilled in the art.

In some embodiments, the third composition comprises a chelating agent. Non-limiting examples of chelating agents include EDTA (ethylenediamine tetraacetic acid), HEDTA (hydroxyethylenediamine triacetic acid), NTA (nitriolotriacetic acid) and citric acid.

In some embodiments, the third composition comprises a clay swelling inhibitor. Non-limiting examples of clay swelling inhibitors include quaternary ammonium chloride and tetramethylammonium chloride. Other clay swelling inhibitors are also possible and will be known to those skilled in the art.

In certain embodiments, the third composition comprises a friction reducer. Non-limiting examples of friction reducers include petroleum distillates, ammonium salts, polyethoxylated alcohol surfactants, and anionic polyacrylamide copolymers. Other friction reducers are also possible and will be known to those skilled in the art.

In some embodiments, the third composition comprises an oxygen scavenger. Non-limiting examples of oxygen scavengers include sulfites, and bisulfites. Other oxygen scavengers are also possible and will be known to those skilled in the art.

In certain embodiments, the third composition comprises a paraffin dispersing additive and/or a asphaltene dispersing additive. Non-limiting examples of paraffin dispersing additives and asphaltene dispersing additives include active acidic copolymers, active alkylated polyester, active alkylated polyester amides, active alkylated polyester imides, aromatic naphthas, and active amine sulfonates. Other paraffin dispersing additives are also possible and will be known to those skilled in the art.

In some embodiments, for the formulations above, the third composition is present in an amount between about 0 wt % about 70 wt %, or between about 0 wt % and about 30 wt %, or between about 1 wt % and about 30 wt %, or between about 1 wt % and about 25 wt %, or between about 1 and about 20 wt %, versus the total microemulsion composition.

In some embodiments, the components of the microemulsion or the amounts of the components may be selected so that the microemulsion is stable over a wide-range of temperatures. For example, the microemulsion may exhibit stability between about −40° F. and about 300° F., or between about −40° F. and about 150° F. Those of ordinary skill in the art will be aware of methods and techniques for determining the range of stability of the microemulsion. For example, the lower boundary may be determined by the freezing point and the upper boundary may be determined by the cloud point and/or using spectroscopy methods. Stability over a wide range of temperatures may be important in embodiments, where the microemulsions are being employed in applications comprising environments wherein the temperature may vary significantly, or may have extreme highs (e.g., desert) or lows (e.g., artic).

In some embodiments, emulsions or microemulsions are provided comprising water, a solvent, and a surfactant, wherein the solvents and surfactants may be as described herein. In some embodiments, as described herein, the solvent comprises more than one type of solvent, for example, two, three, four, five, six, or more, types of solvents. In some embodiment, at least one solvent is selected from the group consisting of unsubstituted cyclic or acyclic, branched or unbranched alkanes having 6-12 carbon atoms, unsubstituted acyclic branched or unbranched alkenes having one or two double bonds and 6-12 carbon atoms, cyclic or acyclic, branched or unbranched alkanes having 9-12 carbon atoms and substituted with only an —OH group, branched or unbranched dialkylether compounds having the formula CₙH₂ₙ₊₁OCₘH₂ₘ₊₁, wherein n+m is between 6 and 16, and aromatic solvents having a boiling point between about 300-400° F. In another embodiment, at least one solvent is selected from the group consisting of cyclic or acyclic, branched or unbranched alkanes having 8 carbon atoms and substituted with only an —OH group and aromatic solvents having a boiling point between about 175-300° F. In some cases, at least one solvent is a terpene. The microemulsion may further comprise addition components, for example, a freezing point depression agent. In some embodiments, at least one solvent is selected from the group consisting of butylbenzene, heavy aromatic naphtha, light aromatic naphtha, 1-nonanol, propylcyclohexane, 1-decanol, dihexylether, 1,7-octadiene, hexylbenzene, nonane, decane, 1-octene, isooctane, octane, heptane, mesitylene, xylenes, toluene, 2-ethyl-1-hexanol, 1-octanol. In some embodiments, at least one solvent is selected from the group consisting of butylbenzene, heavy aromatic naphtha, light aromatic naphtha, 1-nonanol, propylcyclohexane, 1-decanol, dihexylether, 1,7-octadiene, hexylbenzene, nonane, decane, 1-octene, isooctane, octane, heptane, mesitylene, toluene, 2-ethyl-1-hexanol, 1-octanol. In some embodiments, the at least one solvent is not xylene. In some embodiment, at least one solvent is an alpha-olefin.

In some embodiments, composition for injecting into a wellbore are provided comprising an aqueous carrier fluid, and an emulsion or a microemulsion as described herein, wherein the emulsion or the microemulsion is present in an amount between about 0.1 wt % and about 2 wt % versus the total composition. In some embodiments, the emulsion or microemulsion comprises an aqueous phase, a surfactant, a freezing point depression agent, and a solvent as described herein. In some embodiments, the solvent is as described herein. In some cases, the solvent comprises an alpha-olefin, for example, having between 6-12 carbon atoms. In other cases, the solvent comprises a cyclic or acyclic, branched or unbranched alkane having 8-12, or 9-12, or 8, or 9, or 10, or 11, or 12 carbon atoms and substituted with only an —OH group. In some cases, the total amount of solvent present in the emulsion or microemulsion is between about 2 wt % and about 60 wt % and/or the ratio of the aqueous phase to solvent in the emulsion or microemulsion is between 15:1 and 1:10. In some cases, the composition may comprise more than one type of solvent. In some cases, the solvent comprises an alpha-olefin and a terpene. In some cases, the solvent comprises a cyclic or acyclic, branched or unbranched alkane having 8-12 carbon atoms and substituted with only an —OH group and a terpene.

The microemulsions described herein may be formed using methods known to those of ordinary skill in the art. In some embodiments, the aqueous and non-aqueous phases may be combined (e.g., the water and the solvent(s)), followed by addition of a surfactant(s) and optionally other components (e.g., freezing point depression agent(s)) and agitation. The strength, type, and length of the agitation may be varied as known in the art depending on various factors including the components of the microemulsion, the quantity of the microemulsion, and the resulting type of microemulsion formed. For example, for small samples, a few seconds of gentle mixing can yield a microemulsion, whereas for larger samples, longer agitation times and/or stronger agitation may be required. Agitation may be provided by any suitable source, for example, a vortex mixer, a stirrer (e.g., magnetic stirrer), etc.

Any suitable method for injecting the microemulsion (e.g., a diluted microemulsion) into a wellbore may be employed. For example, in some embodiments, the microemulsion, optionally diluted, may be injected into a subterranean formation by injecting it into a well or wellbore in the zone of interest of the formation and thereafter pressurizing it into the formation for the selected distance. Methods for achieving the placement of a selected quantity of a mixture in a subterranean formation are known in the art. The well may be treated with the microemulsion for a suitable period of time. The microemulsion and/or other fluids may be removed from the well using known techniques, including producing the well.

In some embodiments, the emulsion or microemulsion may be prepared as described in U.S. Pat. No. 7,380,606 and entitled “Composition and Process for Well Cleaning,” herein incorporated by reference.

For convenience, certain terms employed in the specification, examples, and appended claims are listed here.

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito: 1999, the entire contents of which are incorporated herein by reference.

Certain compounds of the present invention may exist in particular geometric or stereoisomeric forms. The present invention contemplates all such compounds, including cis- and trans-isomers, R- and S-enantiomers, diastereomers, (D)-isomers, (L)-isomers, the racemic mixtures thereof, and other mixtures thereof, as falling within the scope of the invention. Additional asymmetric carbon atoms may be present in a substituent such as an alkyl group. All such isomers, as well as mixtures thereof, are intended to be included in this invention.

Isomeric mixtures containing any of a variety of isomer ratios may be utilized in accordance with the present invention. For example, where only two isomers are combined, mixtures containing 50:50, 60:40, 70:30, 80:20, 90:10, 95:5, 96:4, 97:3, 98:2, 99:1, or 100:0 isomer ratios are all contemplated by the present invention. Those of ordinary skill in the art will readily appreciate that analogous ratios are contemplated for more complex isomer mixtures.

The term “aliphatic,” as used herein, includes both saturated and unsaturated, nonaromatic, straight chain (i.e., unbranched), branched, acyclic, and cyclic (i.e., carbocyclic) hydrocarbons, which are optionally substituted with one or more functional groups. As will be appreciated by one of ordinary skill in the art, “aliphatic” is intended herein to include, but is not limited to, alkyl, alkenyl, alkynyl, cycloalkyl, cycloalkenyl, and cycloalkynyl moieties. Thus, as used herein, the term “alkyl” includes straight, branched and cyclic alkyl groups. An analogous convention applies to other generic terms such as “alkenyl”, “alkynyl”, and the like. Furthermore, as used herein, the terms “alkyl”, “alkenyl”, “alkynyl”, and the like encompass both substituted and unsubstituted groups. In certain embodiments, as used herein, “aliphatic” is used to indicate those aliphatic groups (cyclic, acyclic, substituted, unsubstituted, branched or unbranched) having 1-20 carbon atoms. Aliphatic group substituents include, but are not limited to, any of the substituents described herein, that result in the formation of a stable moiety (e.g., aliphatic, alkyl, alkenyl, alkynyl, heteroaliphatic, heterocyclic, aryl, heteroaryl, acyl, oxo, imino, thiooxo, cyano, isocyano, amino, azido, nitro, hydroxyl, thiol, halo, aliphaticamino, heteroaliphaticamino, alkylamino, heteroalkylamino, arylamino, heteroarylamino, alkylaryl, arylalkyl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, acyloxy, and the like, each of which may or may not be further substituted).

The term “alkane” is given its ordinary meaning in the art and refers to a saturated hydrocarbon molecule. The term “branched alkane” refers to an alkane that includes one or more branches, while the term “unbranched alkane” refers to an alkane that is straight-chained. The term “cyclic alkane” refers to an alkane that includes one or more ring structures, and may be optionally branched. The term “acyclic alkane” refers to an alkane that does not include any ring structures, and may be optionally branched.

The term “alkene” is given its ordinary meaning in the art and refers to an unsaturated hydrocarbon molecule that includes one or more carbon-carbon double bonds. The term “branched alkene” refers to an alkene that includes one or more branches, while the term “unbranched alkene” refers to an alkene that is straight-chained. The term “cyclic alkene” refers to an alkene that includes one or more ring structures, and may be optionally branched. The term “acyclic alkene” refers to an alkene that does not include any ring structures, and may be optionally branched.

The term “aromatic” is given its ordinary meaning in the art and refers to aromatic carbocyclic groups, having a single ring (e.g., phenyl), multiple rings (e.g., biphenyl), or multiple fused rings in which at least one is aromatic (e.g., 1,2,3,4-tetrahydronaphthyl, naphthyl, anthryl, or phenanthryl). That is, at least one ring may have a conjugated pi electron system, while other, adjoining rings can be cycloalkyls, cycloalkenyls, cycloalkynyls, aryls and/or heterocyclyls.

U.S. provisional application, U.S. Ser. No. 61/888,098, filed Oct. 8, 2013, entitled “System and Method for Well Applications”; U.S. provisional application, U.S. Ser. No. 61/891,316, filed Oct. 15, 2013, entitled “System and Method for Well Applications”; and U.S. Ser. No. 61/946,071, filed Feb. 28, 2014, entitled “Systems, Methods, and Compositions Comprising an Emulsion or a Microemulsion and Chlorine Dioxide for Use in Oil and/or Gas Wells”, are each incorporated herein by reference.

These and other aspects of the present invention will be further appreciated upon consideration of the following Examples, which are intended to illustrate certain particular embodiments, of the invention but are not intended to limit its scope, as defined by the claims.

### EXAMPLES

### Example 1

### On-Site Generation of Chlorine Dioxide

Chlorine dioxide was generated using a 3-chemical precursor system by reacting 25 wt % of sodium chlorite (NaClO₂) with 12.5 wt % of sodium hypochlorite (NaOCl) and 15 wt % hydrochloric acid (HCl) in balance water. Chlorine dioxide was generated between about 1 and about 15,000 ppm in water.

### Example 2

### Injection Rate and Injection Pressure

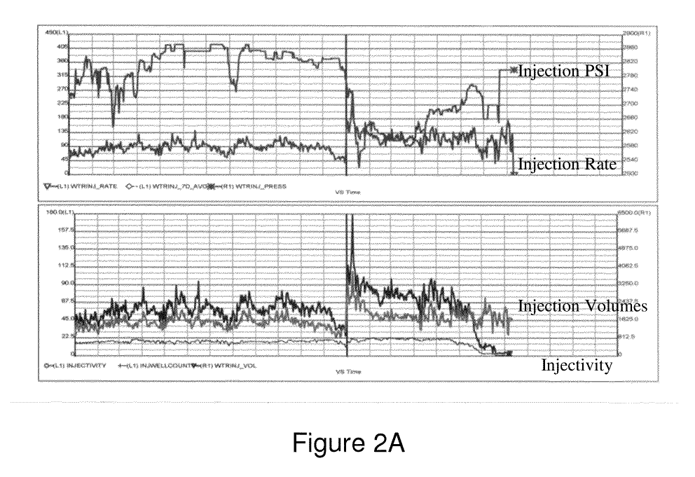

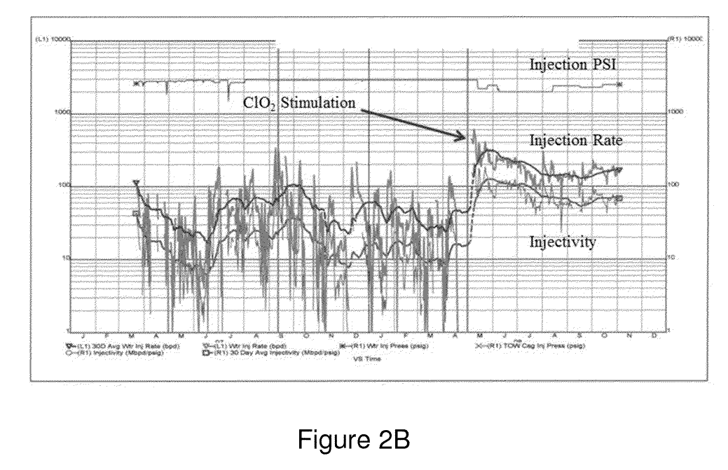

A composition comprising a microemulsion and chlorine dioxide, as described herein, was used in an acidizing operation. Chlorine dioxide, the microemulsion, and 15% hydrochloric acid was added into all well treatment fluids. Water injection rates improved 4 fold with a 50% continued improvement over time (as shown in FIG. 2A). Water injection rates and pressures for an individual well is plotted in FIG. 2B.

### Example 3

### Hydrogen Sulfide

An oil well in an active water flood contained approximately 1800 ppm of hydrogen sulfide. A composition comprising chlorine dioxide, a microemulsion, and an acid was pumped down using coiled tubing into all well treatment fluids. Over time, the hydrogen sulfide was eliminated.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element or a list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of treating a fluid used in oil and gas recovery comprising:
introducing a first composition and a second composition into a fluid wherein the viscosity of the fluid is reduced upon addition of the first composition and the second composition,
wherein the fluid comprises water and a polymer, hydrocarbon, or combinations thereof;
wherein the first composition comprises chlorine dioxide; and
wherein the second composition comprises an emulsion or a microemulsion.

2. The method of claim 1, wherein the first composition and the second composition are combined before addition to the fluid.

3. The method of claim 1, wherein the first composition and the second composition are combined simultaneously in the fluid.

4. The method of claim 1, wherein the first composition is introduced into the fluid before the second composition.

5. The method of claim 1, where in the second composition is introduced into the fluid before the first composition.

6. The method of claim 1, wherein the emulsion, or the microemulsion, comprises one or more of water, a solvent, a surfactant, and/or an alcohol.

7. The method of claim 1, wherein the fluid is located in a storage tank.

8. The method of claim 1, wherein the viscosity of the fluid is reduced by the cleavage of a polymer backbone.

9. The method of claim 1, wherein the viscosity of the fluid is reduced by the cleavage of a covalent bond.

10. The method of claim 1, wherein the viscosity of the fluid is reduced in a pipe, pipeline, trough, ditch, tube, or other liquid conveyance system.

11. The method of claim 1, wherein the viscosity of the fluid is reduced in a pit, pool, pond, or other liquid containment system.

12. The method of claim 1, wherein the viscosity of the fluid is reduced in the underground region of a hydrocarbon well.

13. The method of claim 1, wherein chlorine dioxide is gaseous chlorine dioxide.

14. The method of claim 1, wherein chlorine dioxide is liquid chlorine dioxide.

15. The method of claim 1, wherein the first composition comprises between about 1 ppm and about 15,000 ppm of chlorine dioxide.

16. The method of claim 1, wherein the emulsion or microemulsion is present in an amount of between about 0.1 wt % and about 2.0 wt % of the fluid.

17. The method of claim 6, wherein the emulsion or microemulsion comprises between about 1 wt % and 95 wt % water, or between about 1 wt % and about 90 wt %, or between about 1 wt % and about 60 wt %, or between about 5 wt % and about 60 wt %, or between about 10 wt % and about 55 wt %, or between about 15 wt % and about 45 wt %, versus the total emulsion or microemulsion composition.

18. The method of claim 6, wherein the emulsion or microemulsion comprises between about 2 wt % and 60 wt % solvent, or between 5 wt % and about 40 wt %, or between about 5 wt % and about 30 wt %, versus the total emulsion or microemulsion composition.

19. The method of claim 6, wherein the solvent comprises a terpene.

20. The method of claim 6, wherein the emulsion or microemulsion comprises between about 10 wt % and 60 wt % surfactant, or between about 15 wt % and 55 wt %, or between about 20 wt % and 50 wt %, versus the total emulsion or microemulsion composition

21-26. (canceled)
